(19) United States
(12) Patent Application Publication
(10) Pub. No.: US 2003/0222565 A1
(43) Pub. Date: Dec. 4, 2003

(54) Cathode-ray tube and image display apparatus

(76) Inventors: Reo Asaki, Tokyo (JP); Hiroshi Ohno, Tokyo (JP)

Correspondence Address: COOPER & DUNHAM LLP, 1185 Avenue of the Americas, New York, NY, 10036, US

(21) Appl. No.: 10/378,370

(22) Filed: Mar. 3, 2003

(30) Foreign Application Priority Data
Mar. 5, 2002 (JP) P2002-058666
Sep. 19, 2002 (JP) P2002-272926

(51) Int. Cl. H01J 29/70

(52) U.S. Cl. 313/426

(57) ABSTRACT

A cathode-ray tube including a bulb having a panel, a funnel and a neck, in which inner portion is sealed; an electron gun for emitting electron beams towards a fluorescent screen on inner surface of the panel; an electromagnetic deflection yoke for deflecting a trajectory of the electron beam through electromagnetic deflection effect; and a static deflection electrode for deflecting the trajectory of the electron beam through static deflection effect. The static deflection electrode contains electrode plates through which the inner side of the funnel is divided into two or more units from the neck to the panel. End portions of the electrode plates are placed at positions where they overlap without contact. Those electrode plates entirely cover the inner side of the funnel from the neck to the panel. Different voltages are applied to the electrode plates adjacent to each other.

### CROSS-REFERENCE TO RELATED APPLICATIONS

This application claims priority to Japanese Patent Application No. JP 2002-272926, filed on Sep. 19, 2002, the disclosure of such application being herein incorporated by reference to the extent permitted by law.

### BACKGROUND OF THE INVENTION

1. Field of the Invention

The present invention relates to a cathode-ray tube and an image display apparatus, and more particularly to a cathode-ray tube and an image display apparatus, which, without any increase in deflection power and without distortion of beam spot, can expand a deflection angle and contribute to a wider screen and a flatter and thinner structure of the image display apparatus and further suppress a change in electron beam trajectory and thereby obtaining an optimum image quality.

2. Description of the Related Art

Typically, a cathode-ray tube (CRT) is an apparatus that deflects, as a magnetic field, electron beams emitted from an electron gun placed in a neck inside a bulb composed of a panel and a funnel through a deflection yoke placed outside a funnel cone unit, and thereby scannig a fluorescent screen, and then reproducing an image.

Conventionally, in a deflection method that uses the deflection yoke of the cathode-ray tube, the electron beam is accelerated up to an anode potential and then deflected, thus presenting a problem in which, as deflection angle is increased, a deflection power is increased. In recent years, a demand has been increasing for further enlargement of cathode-ray tube displays. As the screen is enlarged, the total length of the cathode-ray tube is increased, which results in a limitation on the screen size of a final product.

As a way of solving such problem, a method has been tried for expanding the deflection angle of the cathode-ray tube and reducing the total length. However, the expansion of the deflection angle through the deflection yoke brings about the increase in the deflection power. Also, an angle of incidence of the electron beam at a screen corner becomes acute angle, which results in the enlargement of a beam spot distortion and leads to the degradation in image quality. Thus, this method has the difficult problem on practical usage.

It should to be noted that, as a method of expanding the deflection angle through static deflection in addition to the magnetic deflection, for example, Japanese Laid Open Patent Application (H5-6742) has been proposed. However, the condition with regard to the shape and the arrangement of the static deflection electrodes placed inside the funnel of the cathode-ray tube has specifically not yet been proposed in detail. Also, although the static deflection electrode disclosed in the gazette has electrode plates that are divided, the end portions of the respective electrode plates do not overlap, so neither the magnetic shielding effect is provided nor the static deflection can be effectively performed.

Also, the electron gun disclosed in the gazette is placed inside a neck attached to an opening at a back end of a funnel-shape and arranged perpendicularly to a fluorescent screen. As a result, a problem arises in that even if the deflection angle is expanded, the length of the neck portion can not be reduced. Hence, even if the deflection angle is expanded, there is a limitation in making the structure thinner.

### SUMMARY OF THE INVENTION

The present invention has been conceived in view of the above mentioned circumstances and a first preferred embodiment of the present invention aims at providing a cathode-ray tube and an image display apparatus, which without any increase in a deflection power and without any distortion of a beam spot, may expand a deflection angle and contribute to achieving a wider screen and a flatter and thinner structure for the image display apparatus and further suppressing variation in the electron beam trajectory and thereby obtain an optimum image quality. A second preferred embodiment of the present invention aims at reducing the total length of the cathode-ray tube and achieving a substantially thinner structure by using the static deflection in addition to the magnetic deflection, in the cathode-ray tube in which an electron gun is placed substantially in parallel to a fluorescent screen.

In order to attain the above-mentioned aims, the cathode ray tube according to the first preferred embodiment of the present invention includes:

a bulb including a panel, a funnel and a neck and having an inner portion thereof sealed;

an electron gun placed on an inner portion of the neck for emitting an electron beam towards a fluorescent screen on an inner surface of the panel;

a magnetic field deflection unit attached to an outer portion of the funnel for deflecting a trajectory of the electron beam through an electromagnetic deflection effect; and

a static deflection electrode placed on an inner side of the funnel for deflecting the trajectory of the electron beam through a static deflection effect; wherein

the static deflection electrode includes electrode plates that divide the inner side of the funnel into two or more units from the neck toward the panel;

end portions of the respective electrode plates are placed at positions where they overlap without contact;

the electrode plates are configured so as to cover the inner side of the funnel from the neck towards the panel; and

different voltages are applied to the electrode plates that are adjacent to each other.

In such first cathode-ray tube according to the preferred embodiment of the present invention, the plurality of electrode plates are placed inside the funnel, and the voltages are applied to the respective electrode plates, to thereby expand the deflection angle. According to the preferred embodiment of the present invention, the electron beam deflected by the magnetic field deflection unit is statically deflected by the electric field generated by the plurality of electrode plates so that the electron beam trajectory after the magnetic field deflection can be changed so as to expand the deflection angle. The usage of the static deflection enables the expansion of the deflection angle without any increase in the deflection power of the magnetic field deflection unit and without any degradation in the image quality caused by the beam spot distortion.

Also, the preferred embodiment of the present invention jointly has the magnetic shielding effect of shielding the magnetic influence from outside the cathode-ray tube, since the end portions of the electrode plates are placed so as to overlap with each other, in such a way that the plurality of electrode plates for the static deflection serves as the magnetic shield. For this reason, the change of the electron beam trajectory caused by the magnetic influence from outside the cathode-ray tube does not occur, thus, an optimum image quality may be achieved. Also, in the preferred embodiment of the present invention, the glass surface is not in direct proximity to the electron beam. Hence, the problem in which the change of the electron beam trajectory caused by the electric field generated by electrified charges on the glass surface does not arise. As a result, an optimum image quality may be also achieved from this aspect.

Furthermore, in the preferred embodiment of the present invention, the end portions of the plurality of electrode plates for the static deflection are placed so as to overlap with each other. Thus, the trajectory of the electron beam becomes smooth. In particular, even at the corners of the screen, the beam spot is not distorted. Hence, the expansion of the deflection angle may be attained without any degradation in the image quality due to the distortion.

Preferably, the static deflection electrode has at least first, second and third electrode plates for dividing the inner side of the funnel into three or more units from the neck to the panel, a voltage lower than a voltage applied to the fluorescent screen is applied to the closest first electrode plate to the neck,

a voltage higher than the voltage applied to the first electrode plate is applied to the second electrode plate placed at an intermediate position from the neck to the panel, and

a voltage lower than the voltage applied to the second electrode plate is applied to the closest third electrode plate to the panel.

Also preferably, a voltage of 30 to 35 kV is applied to the fluorescent screen, a voltage of 10 to 20 kV is applied to the first electrode plate, a voltage of 30 to 40 kV is applied to the second electrode plate, and a voltage of 5 to 20 kV is applied to the third electrode plate.

Upon having the above-mentioned voltage relation, the advantages of the preferred embodiment of the present invention become more apparent.

Preferably, at the overlapped portion between the electrode plates adjacent to each other, when a side facing on the fluorescent screen is defined as a front surface and when a side concealed from the fluorescent screen is defined as a rear surface, the end portion of the electrode plate to which a high voltage is applied is placed so as to overlap with the rear surface of the end portion of the electrode plate to which a low voltage is applied. The employment of the above-mentioned arrangement relation leads to a smooth change in the electric field at the overlapped portion between the electrode plates, the improvement of the deflection effect of the electron beam, and the improvement of the advantage of the preferred embodiment of the present invention.

Preferably, each of the electrode plates constituting the static deflection electrode is made of a magnetic shielding material for shielding a magnetic influence from outside the cathode-ray tube. Although the magnetic shielding material is not specifically limited, for example, low carbon cold rolled steel and the like may be cited as examples. The respective electrode plates constituting the static deflection electrode are made of magnetic shielding materials to thereby improve the magnetic shielding effect and further improve the advantage of the preferred embodiment of the present invention.

Since having the above-mentioned cathode-ray tube, the first image display apparatus according to the preferred embodiment of the present invention provides the above-mentioned advantage of the preferred embodiment of the present invention.

The second cathode-ray tube according to the preferred embodiment of the present invention includes:

a bulb having a panel and a funnel, in which an inner portion is sealed;

an electron gun, which is placed at the funnel, for emitting an electron beam towards a fluorescent screen on an inner surface of the panel;

a magnetic field deflection unit, which is attached onto the funnel, for deflecting a trajectory of the electron beam through an electromagnetic deflection effect; and

a static deflection electrode, which is placed on an inner side of the funnel, for deflecting the trajectory of the electron beam through a static deflection effect, wherein the electron gun is placed at a position substantially in parallel to the fluorescent screen formed on the inner surface of the panel.

In the second cathode-ray tube according to the preferred embodiment of the present invention, the electron beam deflected by the magnetic field deflection unit is statically deflected by the electric field generated by the static deflection electrode so that the electron beam trajectory after the magnetic field deflection can be changed so as to expand the deflection angle. The usage of the static deflection enables the expansion of the deflection angle without any increase in the deflection power of the magnetic field deflection unit and without any degradation in the image quality caused by the beam spot distortion. That is, it is possible to achieve a thinner structure of the cathode-ray tube and reduce the deflection power. Also, since the angle of incidence of the electron beam can be made wider to especially suppress the distortion of the beam spot at the corners of the screen. Thus, an optimum image can be provided.

Also, in the preferred embodiment of the present invention, the electron gun is placed at a position substantially in parallel to the fluorescent screen formed on the inner surface of the panel. Thus, a thinner structure can be attained as compared with the first cathode-ray tube in which the electron gun is placed at a position substantially perpedicular to the fluorescent screen formed on the inner surface of the panel.

Even in the second cathode-ray tube according to the preferred embodiment of the present invention, the end portions of the plurality of electrode plates for the static deflection may be placed so as to overlap with each other. In that case, the trajectory of the electron beam becomes smooth. In particular, even at the corners of the screen, the beam spot is not distorted. Thus, the deflection angle can be expanded without any degradation in the image quality caused by the distortion.

Preferably, the number of electron guns placed at the positions substantially in parallel to the fluorescent screen formed on the inner surface of the panel is two or more, and the two electron guns serving as a pair are arranged opposite to each other, in the shape of an approximately same straight line. Since the number of electron guns is set at 2, a thinner structure of the cathode-ray tube and a wider screen can be attained as compared with the single electron gun.

Preferably, inside the bulb, a fluorescent screen electrode is formed on the inner surface of the panel, a funnel electrode is formed on the inner surface of the funnel, the fluorescent screen electrode and the funnel electrode can be insulated from each other, so that different voltages can be applied thereto.

Preferably, a voltage lower than the fluorescent screen electrode is applied to the funnel electrode.

Preferably, the static deflection electrode is composed of two or more divided electrode plates, those electrode plates are placed at mutually divided positions, along a trajectory of the electron beam, inside the funnel, and different voltages are applied to the electrode plates adjacent to each other.

Preferably, inside the bulb, the fluorescent screen electrode is formed on the inner surface of the panel, the funnel electrode is formed on the inner surface of the funnel, the static deflection electrode has at least first, second and third electrode plates for dividing the inner side of the funnel into three or more units, a voltage substantially equal to the voltage applied to the fluorescent screen electrode is applied to the closest first electrode plate to the electron gun, a voltage higher than the voltage applied to the first electrode plate is applied to the second electrode plate placed at an intermediate position from the electron gun to the panel, and a voltage lower than the voltage applied to the second electrode plate is applied to the closest third electrode plate to the panel.

Preferably, a voltage of 30 to 35 kV is applied to the fluorescent screen electrode, a voltage of 25 to 30 kV is applied to the funnel electrode, a voltage of 30 to 35 kV is applied to the first electrode plate, a voltage of 30 to 40 kV is applied to the second electrode plate, and a voltage of 5 to 20 kV is applied to the third electrode plate.

When there is the above-mentioned voltage relation, the advantage of the preferred embodiment of the present invention becomes more apparent.

Preferably, each of the electrode plates constituting the static deflection electrode is made of a magnetic shielding material for shielding the magnetic influence from outside the cathode-ray tube. The respective electrode plates constituting the static deflection electrode are made of magnetic shielding materials to thereby improve the magnetic shielding effect.

Since having the above-mentioned cathode-ray tube, the second image display apparatus according to the preferred embodiment of the present invention may provide the above-mentioned advantage of the preferred embodiment of the present invention.

### BRIEF DESCRIPTION OF THE DRAWINGS

The above and other features and advantages of the present invention will become more apparent from the following description of the presently exemplary preferred embodiments of the present invention taken in conjunction with the accompanying drawings, in which:

FIG. 1 is a schematically cross-sectional view showing a cathode-ray tube (CRT) according to a first preferred embodiment of the present invention;

FIG. 2 is a half cross-sectional view showing a main portion in a static deflection electrode shown in FIG. 1;

FIG. 3 is a simulation view showing a trajectory of an electron beam;

FIG. 4 is a schematically cross-sectional view showing a cathode-ray tube (CRT) according to another preferred embodiment of the present invention;

FIG. 5 is a schematically cross-sectional view showing a cathode-ray tube (CRT) according to still another preferred embodiment of the present invention; and

FIG. 6 is a simulation view showing a trajectory of an electron beam in the preferred embodiment shown in FIG. 4.

### DESCRIPTION OF THE PREFERRED EMBODIMENTS

Preferred embodiments of the present invention will be described below on the basis of the examples of embodiment shown in the attached drawings.

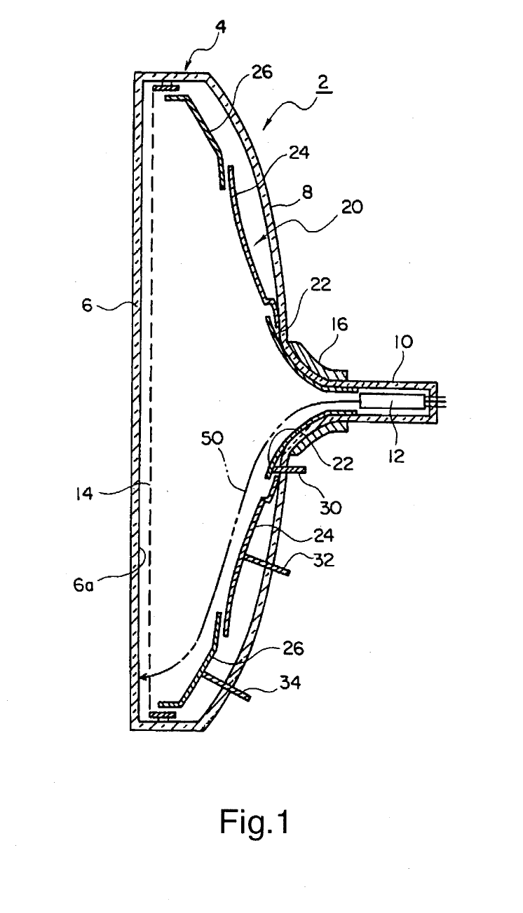

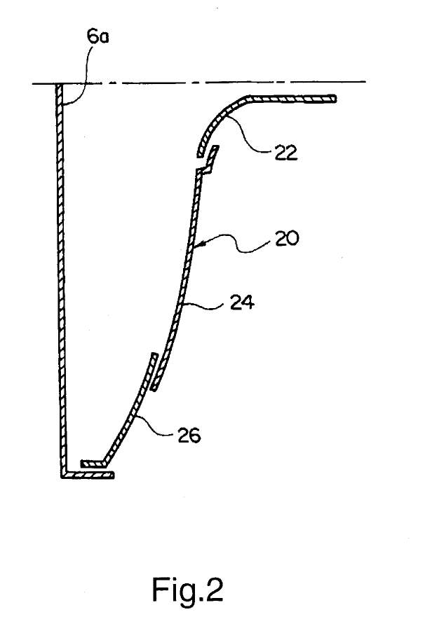

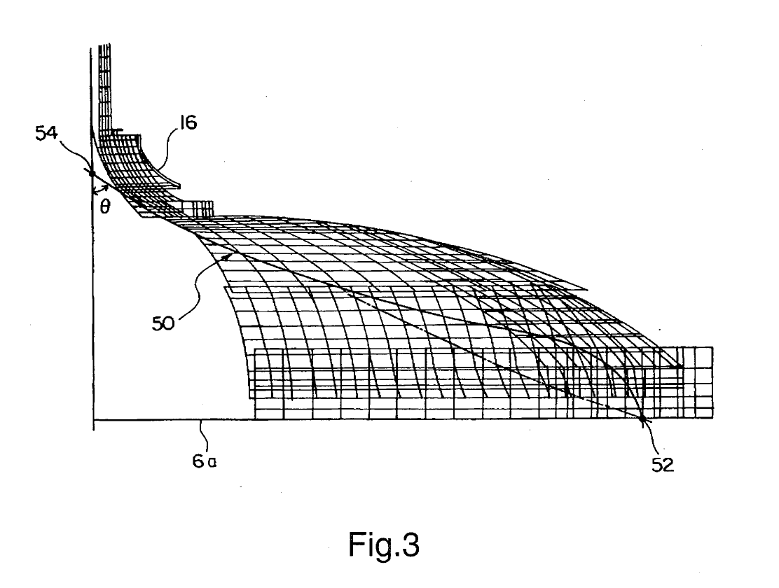

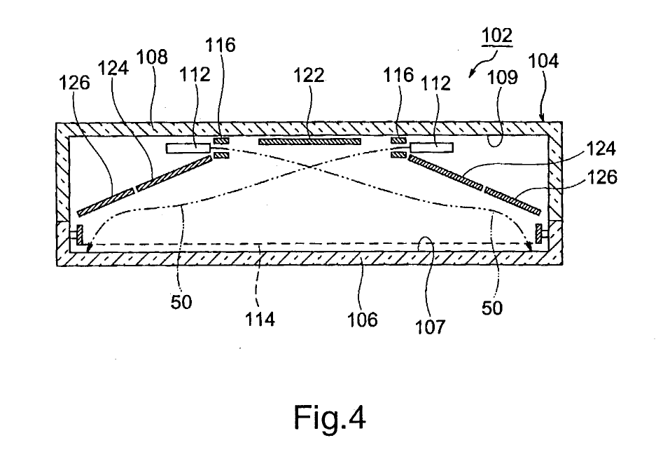

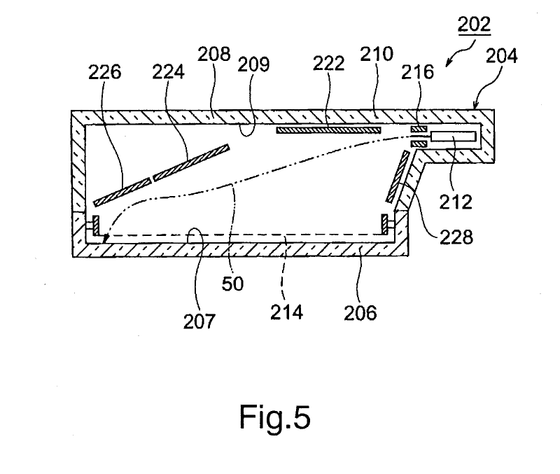

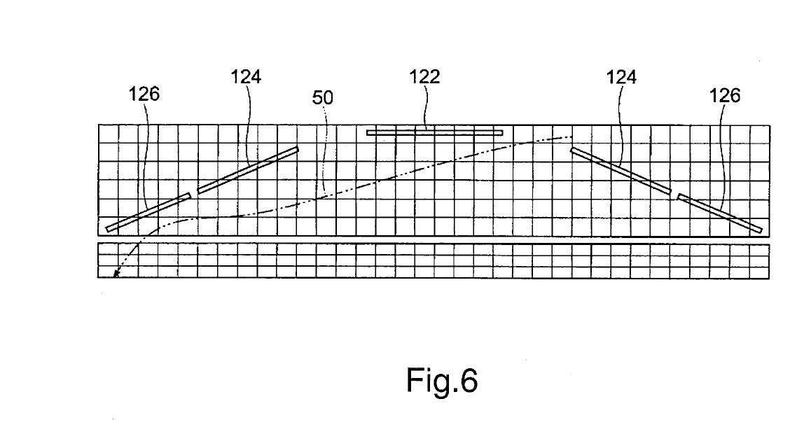

FIG. 1 is a schematically cross-sectional view showing a cathode-ray tube (CRT) according to a first embodiment in the preferred embodiment of the present invention, FIG. 2 is a half cross-sectional view showing a main portion in a static deflection electrode shown in FIG. 1, FIG. 3 is a simulation view showing a trajectory of an electron beam in the embodiment shown in FIGS. 1, 2, FIG. 4 is a schematically cross-sectional view showing a cathode-ray tube (CRT) according to another embodiment in the preferred embodiment of the present invention, FIG. 5 is a schematically cross-sectional view showing a cathode-ray tube (CRT) according to still another embodiment in the preferred embodiment of the present invention, and FIG. 6 is a simulation view showing a trajectory of an electron beam in the embodiment shown in FIG. 4.

First Preferred Embodiment

As shown in FIG. 1, a color television receiver serving as the image display apparatus according to this preferred embodiment includes a color cathode-ray tube (CRT) 2. That CRT 2 has a bulb 4 whose inside is sealed in vacuum condition. The bulb 4 has a panel 6, a funnel 8 and a neck 10. A fluorescent screen 6a is formed on the inner surface of the panel 6 so that it can be set to an anode potential (30 to 35 kV).

An electron gun 12 is built in the neck 10 so that an electron beam 50 is emitted towards the fluorescent screen 6a on the inner surface of the panel 6. An aperture grill 14 serving as a color selection mechanism is placed on the inner side of the panel 6. In this embodiment, the electron gun 12 is placed substantially perpendicular to the fluorescent screen 6a.

In this preferred embodiment, an electromagnetic deflection yoke (a magnetic field deflection unit) 16 for deflecting the trajectory of the electron beam 50 on the basis of electromagnetic deflection effect is placed on the outer side of the cone portion (the connecting portion between the funnel 8 and the neck 10) in the funnel 8. Also, in this preferred embodiment, a static deflection electrode 20 is placed so as to entirely cover the inner side of the funnel 8 from the neck 10 to the panel 6. That is, this CRT 2 is designed so as to jointly use two kinds of deflection methods, in such a way that the magnetic field deflection through the deflection yoke 16 is used as the main deflection and the static deflection through the static deflection electrode 20 is used as the sub deflection.

Moreover, the static deflection electrode 20 in this preferred embodiment is composed of first, second and third electrode plates 22, 24 and 26 so that the inner side of the funnel 8 is divided into three units from the neck to the panel. Each of the respective electrode plates 22, 24 and 26 has the cone shape or the skirt shape along the inner surface of the funnel 8, and the end portions of the respective electrode plates 22, 24 and 26 are placed at the overlapped positions without contact. That is, one end portion of the second electrode plate 24 overlaps with the rear surface of the end portion of the first electrode plate 22, and the other end portion of the second electrode plate 24 overlaps with the rear surface of the end portion of the third electrode plate 26. It should be noted that, in those overlapped portions between the end portions, the side facing on the fluorescent screen 6a is defined as the front side, and the side concealed from the fluorescent screen 6a is defined as the rear surface. The length of the overlapped portion between the end portions is not especially limited. Preferably, it is in a range between 1 mm and about several 10 mm. Further preferably, it is in a range between several mm and ten-odd mm. When the length of the overlapped portion is too short, the effect of the preferred embodiment of the present invention is reduced, while when it is too long, it constitutes a waste of material.

Those electrode plates 22, 24 and 26 are directly fixed on the inner surface of the funnel 8 or fixed on the inner side of the funnel through an insulation supporting member attached to the funnel 8. In this preferred embodiment, each of the electrode plates 22, 24 and 26 is made of a magnetic shielding material, such as low carbon cold rolled steel and the like.

Glass constituting the funnel 8 is configured such that extraction electrode pins 30, 32 and 34 are embedded therein. The extraction electrode pins 30, 32 and 34 are linked to the electrode plates 22, 24 and 26, respectively. Respective predetermined voltages can be applied to the respective electrode plates 22, 24 and 26 from the outside. It should be noted that, in such a way that the respective different voltages can be applied to the respective electrode plates 22, 24 and 26, the pins may be individually attached. Alternatively, a high voltage sent from one electrode pin may be divided and sent to the respective electrode plates.

In this preferred embodiment, a voltage of 10 to 20 kV, which is a voltage lower than the voltage (the anode potential) applied to the fluorescent screen 6a, is applied through the extraction electrode pin 30 to the closest first electrode plate 22 to the neck 10. Also, a voltage of 30 to 40 kV, which is a voltage higher than the voltage applied to the first electrode plate 22, is applied through the extraction electrode pin 32 to the second electrode plate 24 placed at an intermediate position from the neck 10 to the panel 6. Moreover, a voltage of 5 to 20 kV, which is a voltage lower than the voltage applied to the second electrode plate 24, is applied through the extraction electrode pin 34 to the closest third electrode plate 22 to the panel 6.

The reason why the voltage of 10 to 20 kV, which is the voltage lower than the voltage applied to the fluorescent screen 6a, is applied to the closest first electrode plate 22 to the neck 10 is to improve the magnetic field deflection efficiency at the deflection yoke 16. In other words, at the time of the magnetic field deflection, the drop in the acceleration voltage of the electron beam 50 enables the reduction in the deflection power.

The CRT 2 according to this preferred embodiment and the color television receiver having such CRT can achieve the expansion of a deflection angle by placing the plurality of electrode plates 22, 24 and 26 inside the funnel 8 and applying the voltages to the respective electrode plates 22, 24 and 26 and then carrying out the static deflection. In this preferred embodiment, the electron beam 50 deflected by the deflection yoke 16 is statically deflected by the electric field generated by the plurality of electrode plates 22, 24 and 26 so that an electron beam trajectory after the magnetic field deflection can be changed so as to expand the deflection angle. Also, the usage of the static deflection enables the increase in the deflection angle without any increase in the deflection power of the deflection yoke 16 and without any degradation in the image quality caused by beam spot distortion.

Also, in this preferred embodiment, in such a way that the plurality of electrode plates 22, 24 and 26 for the static deflection serve as the magnetic shield, the end portions of the electrode plates 22, 24 and 26 are placed so as to overlap with each other to thereby shield the magnetic influence from outside the CRT 2. Thus, this jointly has the magnetic shielding effect. For this reason, the change of the electron beam trajectory caused by the magnetic influence from outside the CRT 2 is not brought about. Thus, an optimum image quality can be obtained. Also, in this preferred embodiment, the glass surface of the funnel 8 is not in direct proximity to the electron beam 50. Hence, the change of the electron beam trajectory caused by the electric field generated by electrified charges on the glass surface is prevented from occurring. From this aspect, an optimum image quality can be obtained.

Furthermore, in this preferred embodiment, since the end portions of the plurality of electrode plates 22, 24 and 26 for the static deflection are placed so as to overlap with each other, the trajectory of the electron beam 50 becomes smooth. In particular, even at the corners of the screen, the electron beam 50 is incident at an angle substantially perpendicular to the fluorescent screen 6a. As a result, the beam spot is not distorted. Thus, the expansion of the deflection angle can be attained without any degradation in the image quality caused by the distortion.

It should to be noted that, in the above-mentioned preferred embodiment, the static deflection electrode 20 may be divided into three or more units. In that case, it is preferable that the second electrode plate 24 placed at the middle is further divided. As the number of divisions is increased, the trajectory of the electron beam is easily controlled. However, the manufacturing and the mounting of the electrode plate tend to be difficult. Thus, it is preferable that the number of divisions of the static deflection voltage 20 be approximately from 2 to 5, and it is especially preferable that be 3.

Second Preferred Embodiment

As shown in FIG. 4, a color television receiver according to a second preferred embodiment of the present invention includes a color cathode-ray tube (CRT) 102. The CRT 102 has a bulb 104 that has its inside portion sealed under vacuum.

In this preferred embodiment, the bulb 104 has the shape of an entirely flat rectangular box and includes a panel 106 serving as a display surface on which image is displayed, and a funnel 108 that is joined to the rear surface of the panel 106 and defines the flat box shape. A fluorescent screen electrode 107 is formed on the inner surface of the panel 106 so that it can be set to an anode potential (i.e., 30 to 35 kV). The fluorescent screen electrode 107 is formed, for example, by depositing aluminum film on a fluorescent substance coating layer constituting the fluorescent screen on the inner surface of the panel 106.

A funnel electrode 109 is formed on the inner surface of the funnel 108. The funnel electrode 109 is formed, for example, by coating carbon film on the inner surface of the funnel 108. The funnel electrode 109 is formed on the substantially entire surface along the inner surface of the funnel 108 and extended up to the portion joined to the panel 106. However, it is insulated from the fluorescent screen electrode 107, and a different voltage is applied thereto. A voltage lower than that of the fluorescent screen electrode 107 is applied to the funnel electrode 109. For example, it can be set to 25 to 30 kV.

In this preferred embodiment, a pair of electron guns 112 is placed at a position substantially in parallel to a fluorescent screen formed on the inner surface of the panel 106, inside the bottom plate of the funnel 108. Moreover, those two electron guns serving as the pair are placed opposite so as to face on each other, in the shape of an approximately straight line. Electron beams 50 emitted from the respective electron guns 112 pass and are deflected through deflection yokes (magnetic field deflection apparatus) 116 placed in front of the respective electron guns 112. Then, they cross each other substantially at the center and arrive at the fluorescent screen. The two electron guns 112 scan each half of the fluorescent screen at a time, and the halves are joined at the screen center to thereby create one image. It should to be noted that, an aperture grill 114 serving as a color selection mechanism is placed on the inner side of the fluorescent screen.

In this preferred embodiment, in addition to the deflection of the electron beam 50 through the electromagnetic deflection effect of the deflection yoke 116, the electron beam 50 is deflected by the static deflection electrode placed inside the funnel 108. In this preferred embodiment, the static deflection electrode is composed of a first electrode plate 122, a second electrode plate 124 and a third electrode plate 126. Those electrode plates 122, 124 and 126 are arranged at mutually divided positions along the trajectory of the electron beam 50, inside the funnel 108. Thus, different voltages are applied to the electrode plate adjacent to each other. It should be noted that, those electrode plates 122, 124 and 126 entirely cover the inner side of the funnel 108, in the portions except an outlet of the electron beam 50 from the deflection yoke 116.

The first electrode plate 122 is placed on an inner side of the bottom plate in the funnel 108, between the pair of electron guns 112 placed opposite to each other. The second and third electrode plates 124, 126 are extended in the shape of a cone or skirt so as to surround up to the vicinity of the frame of the aperture grill 114, from the vicinity of the deflection yoke 116 located on the electron beam output side of the electron gun 112, inside the funnel 108. The second electrode plate 124 is placed on the side of the electron gun. And, the third electrode plate 126 is placed in the vicinity of the frame of the aperture grill 114.

In order to apply different voltages to the respective electrode plates 122, 124 and 126, respective pin electrodes are embedded in the glass constituting the funnel 108 so that different voltages can be sent to the respective electrode plates from the outside. Alternatively, a high voltage sent from one pin electrode may be divided and sent to the respective electrode plates 122, 124 and 126. In this preferred embodiment, each of the electrode plates 122, 124 and 126 is made of a magnetic shielding material such as low carbon cold rolled steel and the like.

A voltage equivalent to the voltage applied to the fluorescent screen electrode 107 is applied to the first electrode plate 122. A voltage higher than the voltage applied to the first electrode plate 122 is applied to the second electrode plate 124 placed at an intermediate position between the electron gun 112 and the panel 106. In addition, a voltage lower than the voltage applied to the second electrode plate 124 is applied to the closest third electrode plate 126 to the panel 106.

More specifically, a voltage of 30 to 35 kV is applied to the fluorescent screen electrode 107. A voltage of 25 to 35 kV is applied to the funnel electrode 109. A voltage of 30 to 35 kV is applied to the first electrode plate 122. A voltage of 30 to 40 kV is applied to the second electrode plate 124. And, a voltage of 5 to 20 kV is applied to the third electrode plate 126.

The CRT 102 according to this preferred embodiment and the color television receiver equipped with such CRT can achieve the expansion of the deflection angle by placing the plurality of electrode plates 122, 124 and 126 inside the funnel 108 and applying the voltages to the respective electrode plates 122, 124 and 126 and then carrying out the static deflection. In this preferred embodiment, the electron beam 50 deflected by the deflection yoke 116 is statically deflected by the electric field generated by the plurality of electrode plates 122, 124 and 126 so that the electron beam trajectory after the magnetic field deflection can be changed so as to expand the deflection angle. Also, the usage of the static deflection enables the increase in the deflection angle without any increase in the deflection power of the deflection yoke 116 and without any degradation in the image quality caused by the beam spot distortion.

Also, in this preferred embodiment, since the plurality of electrode plates 122, 124 and 126 for the static deflection are made of a magnetic shielding material, there is combined a magnetic shielding effect of shielding the magnetic influence from outside the CRT 102. For this reason, the change of the electron beam trajectory caused by the magnetic influence from outside the CRT 102 is prevented from occurring. Thus, an optimum image quality can be obtained.

Moreover, due to the plurality of electrode plates 122, 124 and 126 for the static deflection, the trajectory of the electron beam 50 becomes smooth. In particular, even at the corners of the screen, the electron beam 50 is incident at an angle substantially perpendicular to the fluorescent screen. Consequently, the beam spot is not distorted. As a result, the expansion of the deflection angle can be attained without any degradation in the image quality caused by the distortion.

Furthermore, in this preferred embodiment, the electron guns 112, 112 are placed at the positions substantially in parallel to the fluorescent screen formed on the inner surface of the panel 106. Thus, it is possible to achieve a thinner structure than that of the cathode-ray tube shown in FIG. 1, in which the electron guns 112, 112 are placed at positions substantially perpendicular to the fluorescent screen formed on the inner surface of the panel 106. Especially in this preferred embodiment, the number of electron guns is set at 2. Hence, a thinner structure of the cathode-ray tube and a wider screen can be achieved as compared with the single electron gun.

It should to be noted that, in the above-mentioned preferred embodiments, the static deflection electrode may be divided into three or more units. In that case, it is preferable that the second electrode plate 124 placed at the middle be further divided. As the number of divisions is increased, the trajectory of the electron beam becomes easier to control. However, the manufacturing and the mounting of the electrode plate tends to become difficult. Thus, a preferable number of divisions of the static deflection voltage is 2 to 5, and it is especially preferable to be 3.

Third Preferred Embodiment

As shown in FIG. 5, a color television receiver according to a third preferred embodiment of the present invention includes a color cathode-ray tube (CRT) 202. The CRT 202 has a bulb 204 whose inside is sealed in vacuum condition. This CRT 202 is an example of variation of the CRT 102 shown in FIG. 4. However, the number of electron guns is different, and the other configurations are similar. The portions that differ from the preferred embodiment shown in FIG. 4 will be described below in more detail.

In this preferred embodiment, the bulb 204 has a shape of an entirely flat rectangular box and includes a panel 206 serving as a display surface on which an image is displayed, and a funnel 208 that is joined to the rear surface of the panel 206 and defines the entirely flat box shape.

In this third preferred embodiment, a neck 210 is formed integrated on one side of the funnel 208. Inside thereof, an electron gun 212 is attached substantially in parallel to the fluorescent screen of the panel 206. A deflection yoke 216 is attached in front of the electron gun 212. Then, a static deflection electrode, which has the shape of a cone or a skirt, is placed towards a peripheral frame of an aperture grill 214 from the deflection yoke 216. The static deflection electrode is composed of a first electrode plate 222, a second electrode plate 224, a third electrode plate 226 and a fourth electrode plate 228. Such first electrode plates are configured such that different voltages can be applied thereto.

The first electrode plate 222 is placed in the vicinity of the deflection yoke 216, inside the bottom plate of the funnel 208. The second electrode plate 224 and the third electrode plate 226 are formed in a course towards the frame of the aperture grill 214 from the first electrode plate 222, inside the funnel 208, and they are separated from each other. The third electrode plate 226 is placed in the vicinity of the frame of the aperture grill 214. The second electrode plate 224 is placed at an intermediate position between the first electrode plate 222 and the third electrode plate 226. The fourth electrode plate 228 is placed inside the shortest side plate towards the panel 206 from the neck 210 in the funnel 208.

In order to apply different voltages to the respective electrode plates 222, 224, 226 and 228, respective pin electrodes are embedded in the glass constituting the funnel 208 so that different voltages can be applied to the respective electrode plates from the outside. Alternatively, a high voltage applied from one pin electrode may be divided and applied to the respective electrode plates 222, 224, 226 and 228. In this preferred embodiment, each of the electrode plates 222, 224, 226 and 228 is made of a magnetic shielding material such as low carbon cold rolled steel and the like.

A voltage equivalent to the voltage applied to the fluorescent screen electrode 207 is applied to the first electrode plate 222. A voltage higher than the voltage applied to the first electrode plate 222 is applied to the second electrode plate 224. A voltage lower than the voltage applied to the second electrode plate 224 is applied to the third electrode plate 226. And, a voltage equivalent to a funnel electrode 209 is applied to the fourth electrode plate 224.

Specifically, a voltage of 30 to 35 kV is applied to the fluorescent screen electrode 207. A voltage of 25 to 35 kV is applied to the funnel electrode 209. A voltage of 30 to 35 kV is applied to the first electrode plate 222. A voltage of 30 to 40 kV is applied to the second electrode plate 224. A voltage of 5 to 20 kV is applied to the third electrode plate 226. Also, a voltage of 25 to 30 kV is applied to the fourth electrode plate 228.

The CRT 202 according to this preferred embodiment and the color television receiver equipped with such CRT provide the advantages similar to those shown in FIG. 4. However, when attempts are made so as to achieve a wider screen and a flatter structure at the same time, the example of embodiment shown in FIG. 4 is preferable.

It should to be noted that, the preferred embodiment of the present invention is not limited to the above-mentioned examples of preferred embodiments. The preferred examples may be modified or combined within the range and scope of the preferred embodiments of the present invention.

Other examples of preferred embodiments of the present invention will be described below on the basis of more detailed implementations. However, it is to be noted that the preferred embodiments of the present invention are not limited to those implementations.

First Example of Implementation

In this implementation, the trajectory of the electron beam attained for the case of employing the electrode shape and the electrode arrangement shown in FIGS. 1 and 2 was determined by a simulated calculation. The voltages applied to the respective electrode plates 22, 24 and 26 were as follows. The voltage applied to the first electrode plate 22 was 15 kV. The voltage applied to the second electrode plate 24 was 35 kV. The voltage applied to the third electrode plate 26 was 10 kV. And, the voltage applied to the fluorescent screen 6a (the anode) was 30 kV. In the simulation, an electrical field space was calculated by using a surface charge method, and the electron beam trajectory when the electron beam was emitted to this space was simulated.

The electrode plates used in the static deflection were placed so as to overlap with each other as shown in FIGS. 1, 2. The order in which the electrodes overlap is such that, at the overlapped portion between the first electrode plate 22 and the second electrode plate 24, the end portion of the second electrode plate 24 was placed on the rear surface of the first electrode plate 22, and at the overlapped portion between the second electrode plate 24 and the third electrode plate 26, the end portion of the second electrode plate 24 was placed on the rear side of the third electrode plate 26. This reason was to make the deflection angle through the electric field of the electron beam 50 as large as possible. This electrode shape and this electrode arrangement provide the trajectory of the electron beam 50, as shown in FIG. 3. The realization of the deflection angle corresponding to 136° could be confirmed.

It should to be noted that, a deflection angle 20 is explained as below. As shown in FIG. 3, in the trajectory of the electron beam 50 arriving at the corner of the fluorescent screen 6a, when an arrival point 52 at the fluorescent screen 6a and an axial direction center 54 of the deflection yoke 16 in the axial core of the CRT are connected to each other through an inclined straight line and when a cross angle between the inclined straight line and the axial core is assumed to be θ, the deflection angle 2θ is the value equivalent to two times the above-mentioned cross angle.

From the CRT in this implementation, the following advantages are obtained.

(1) A drop in the deflection power can be attained.

(2) Since the total length of the CRT can be reduced, a thin type TV can be achieved.

(3) Even if the deflection angle is expanded, the beam input angle to the fluorescent screen 6a is large. Thus, the beam spot distortion at the screen corner can be suppressed to thereby provide an optimum image quality.

(4) Since the electrode plate jointly serves as the magnetic shield, another different magnetic shield need not be installed. Thus, cost reduction can be achieved.

(5) The present example may be used not only for one beam but also for a three-beam deflection. Thus, this can be applied to even a color CRT.

Second Example of Implementation

In a second example of implementation of the preferred embodiment of the present invention, the trajectory of the electron beam attained in the case of the employments of the electrode shape and the electrode arrangement shown in FIG. 4 was determined by a simulation calculation. The voltages applied to the fluorescent screen electrode 107, the funnel electrode 109 and the respective electrode plates 222, 224 and 226 were as follows. The voltage applied to the fluorescent screen electrode 107 was 30 kV. The voltage applied to the funnel electrode 109 was 25 kV. The voltage applied to the first electrode plate 122 was 30 kV. The voltage applied to the second electrode plate 124 was 40 kV. And, the voltage applied to the third electrode plate 126 was 10 kV. In the simulation, the electrical field space was calculated by using a surface charge method, and the electron beam trajectory when the electron beam was emitted to this space was simulated.

This electrode shape and the electrode arrangement provide the trajectory of the electron beam 50, as shown in FIG. 6. Thus, the realization of the intended beam trajectory could be confirmed. It should to be noted that, the result illustrated in FIG. 6 was the electron beam trajectory along the longitudinal axis of the screen. However, the similar electron beam trajectory could be attained even at a different scanning position.

From the CRT in this implementation, the following advantages are obtained.

(1) Since the total length of the CRT can be reduced, a thin type TV can be achieved.

(2) In the cathode-ray tube having the two electron guns, the total length reduction effect is larger as compared to the single case.

(3) Since the deflection angle is narrower, a drop in the deflection power can be attained.

(4) Since the beam input angle is wider, the beam spot distortion at the screen corner can be suppressed to thereby provide an optimum image quality.

(5) This can be used not only for the one-beam scan but also for the three-beam scan. Thus, the above-mentioned effects can be achieved even in a color cathode-ray tube.

While the present invention has been described in its preferred embodiments, it is to be understood that the invention is by no means limited to such preferred preferred embodiments. Accordingly, any modifications, variations, combinations and sub-combinations of the present invention are possible in the light of the above teachings. It is therefore to be understood that within the scope of the appended claims the present invention may be practiced otherwise than as specifically described.

What is claimed is:

1. A cathode-ray tube comprising:
a bulb including a panel, a funnel and a neck and having an inner portion thereof sealed;
an electron gun placed on an inner portion of said neck for emitting an electron beam towards a fluorescent screen on an inner surface of said panel;
a magnetic field deflection unit attached to an outer portion of said funnel for deflecting a trajectory of said electron beam through an electromagnetic deflection effect; and
a static deflection electrode placed on an inner side of said funnel for deflecting the trajectory of said electron beam through a static deflection effect; wherein
said static deflection electrode includes electrode plates that divide the inner side of said funnel into two or more units from said neck toward said panel;
end portions of the respective electrode plates are placed at positions where they overlap without contact;
said electrode plates are configured so as to cover the inner side of said funnel from said neck towards said panel; and
different voltages are applied to said electrode plates that are adjacent to each other.

2. The cathode-ray tube according to claim 1, wherein
said static deflection electrode has at least first, second and third electrode plates for dividing the inner side of said funnel into three or more units from said neck towards said panel;
a voltage lower than a voltage applied to said fluorescent screen is applied to a first electrode plate which is closest to said neck;
a voltage higher than the voltage applied to said first electrode plate is applied to the second electrode plate placed at an intermediate position between said neck and said panel; and
a voltage lower than the voltage applied to said second electrode plate is applied to a third electrode plate which is closest to said panel.

3. The cathode-ray tube according to claim 2, wherein
a voltage of 30 to 35 kV is applied to said fluorescent screen;
a voltage of 10 to 20 kV is applied to said first electrode plate;
a voltage of 30 to 40 kV is applied to said second electrode plate; and
a voltage of 5 to 20 kV is applied to said third electrode plate.

4. The cathode-ray tube according to one of claims 1 to 3, wherein in an overlapping portion between adjacent electrode plates, an end portion of the electrode plate to which a higher voltage is applied is placed so as to overlap with a rear surface of an end portion of the electrode plate to which a lower voltage is applied, wherein a side facing said fluorescent screen is determined as a front surface and a side concealed from said fluorescent screen is determined as the rear surface.

5. The cathode-ray tube according to one of claims 1 to 4, wherein each of the electrode plates constituting said static deflection electrode is made of a magnetic shielding material for shielding a magnetic influence from outside the cathode-ray tube.

6. An image display apparatus including the cathode-ray tube according to one of claims 1 to 5.

7. A cathode-ray tube comprising:
a bulb including a panel, a funnel and a neck and having an inner portion thereof sealed;
an electron gun placed on an inner portion of said neck for emitting an electron beam towards a fluorescent screen on an inner surface of said panel;
a magnetic field deflection unit attached to an outer portion of said funnel for deflecting a trajectory of said electron beam through an electromagnetic deflection effect; and
a static deflection electrode placed on an inner side of said funnel for deflecting the trajectory of said electron beam through a static deflection effect; wherein
wherein said electron gun is placed at a position substantially in parallel to the fluorescent screen formed on the inner surface of said panel.

8. The cathode-ray tube according to claim 7, wherein
a number of electron guns placed at the positions substantially in parallel to the fluorescent screen formed on the inner surface of said panel is two or more; and
two electron guns serving as a pair are arranged in an approximately same straight line and in opposition to each other.

9. The cathode-ray tube according to claim 7 or 8, wherein
inside said bulb, a fluorescent screen electrode is formed on an inner surface of said panel, and a funnel electrode is formed on an inner surface of said funnel; and
different voltages are applied to said fluorescent screen electrode and said funnel electrode upon establishing isolation between each other.

10. The cathode-ray tube according to claim 9, wherein a voltage lower than of said fluorescent screen electrode is applied to said funnel electrode.

11. The cathode-ray tube according to one of claims 7 to 10, wherein said static deflection electrode includes two or more divided electrode plates;
said electrode plates are placed inside said funnel at mutually divided positions along a trajectory of said electron beam; and
different voltages are applied to adjacent electrode plates.

12. The cathode-ray tube according to claim 11, wherein
inside said bulb, a fluorescent screen electrode is formed on an inner surface of said panel;
said funnel electrode is formed on the inner surface of said funnel;
said static deflection electrode has at least first, second and third electrode plates for dividing the inner side of said funnel into three or more units;
a voltage substantially equal to the voltage applied to said fluorescent screen electrode is applied to a first electrode plate which is closest to said electron gun;
a voltage higher than the voltage applied to said first electrode plate is applied to the second electrode plate placed at an intermediate position between said electron gun and said panel; and
a voltage lower than the voltage applied to said second electrode plate is applied to the a third electrode plate which is closest to said panel.

13. The cathode-ray tube according to claim 12, wherein a voltage of 30 to 35 kV is applied to said fluorescent screen electrode, a voltage of 25 to 30 kV is applied to said funnel electrode, a voltage of 30 to 35 kV is applied to said first electrode plate, a voltage of 30 to 40 kV is applied to said second electrode plate, and a voltage of 5 to 20 kV is applied to said third electrode plate.

14. The cathode-ray tube according to one of claims 11 to 13, wherein each of the electrode plates constituting said static deflection electrode comprises a magnetic shielding material for shielding a magnetic influence from outside the cathode-ray tube.

15. An image display apparatus having the cathode-ray tube according to one of claims 7 to 14.
